(19) United States
(12) Patent Application Publication
(10) Pub. No.: US 2008/0305456 A1
(43) Pub. Date: Dec. 11, 2008

(54) Dental implant stabilizing device

(76) Inventor: Dan Rosen, Calabasas, CA (US)

Correspondence Address: Lauson & Tarver LLP, 880 Apollo Street, SUITE 301, El Segundo, CA, 90245, US

(21) Appl. No.: 11/811,670

(22) Filed: Jun. 11, 2007

(51) Int. Cl. A61C 8/00

(52) U.S. Cl. 433/173

(57) ABSTRACT

A stabilizing device for holding a dental implant in place essentially during the period between a dental implantation surgery and the osseointegration of the implant after the surgery. The device includes an implant, a plate member and a fastener for securing the plate member to the implant after the plate member is placed over the mouth side of the maxillary bone.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to dental implants and related devices and more particularly to a dental implant stabilizing device for holding a dental implant in place especially during its reinforcement period after a dental implantation surgery.

Generally, after a typical dental implantation surgery, especially the one which is performed on the upper jaw of a patient, the ossification of the bone, which is usually placed in a sinus cavity around the threaded portion of the dental implant, takes a considerable amount of time. During this period, the implant needs to be stable and held fast in the same position which often proves to be very difficult to maintain. However, the art comes up with several devices or systems which help overcome this problem.

For example, U.S. Pat. No. 5,133,662 to Metcalfe discloses a tooth implant device. The device comprises an anchoring member, which in turn comprises a tooth support receiving member and a means for firmly gripping the bone which supports the natural teeth. The tooth support receiving member receives a tooth support upon which an artificial tooth is to be supported. The tooth support allows for limited movement of the artificial tooth.

U.S. Pat. No. 4,702,697 to Linkow discloses a prefabricated partial subperiosteal implant comprising a prefabricated elongated plate of pliable, work-hardenable material. A short projection extends from one surface of the plate and defines an aperture which receives a post for supporting an artificial tooth structure. The prefabricated implant is inserted through a lateral incision in the gum tissue, and is then molded to the bone. Subsequently the incision is sutured and the post is installed on the support plate.

U.S. Pat. No. 5,456,601 to Sendax discloses a sinus dental implant stabilizer comprising an elongated implant with an internal recess at one end, an insert removably fitting into the recess, a washer to be held between the implant and the insert as it is fitted in the recess, and a nut to fit into the threaded portion of the implant from the opposite side of the insert and the washer. In order to use the stabilizer, as the implant is fitted into the maxillary bone, the nut is fitted through the sinus cavity into the threaded portion of the implant till it gets into contact with the other side of the maxillary bone. As the nut is finally tightened against the maxillary bone, the implant is secured firmly.

Each of the devices disclosed in the above references basically comprises a dental implant itself. Therefore, there is no such “independent” device in the art which is capable of holding a conventional dental implant in place.

### SUMMARY

The present invention is a dental implant stabilizing device for holding a dental implant in place during its reinforcement period after a dental implantation surgery. The device comprises a dental implant for placement through the maxillary bone into the maxillary sinus, a plate member for placement over the mouth side of the maxillary bone and a fastener for securing the plate member to the implant after the plate member is placed over the mouth side of the maxillary-bone. The plate member is adapted to stabilize the implant after it is secured to the implant.

### BRIEF DESCRIPTION OF THE FIGURES

FIG. 1 is a side view of the dental implant stabilizing device of the present invention.

FIG. 2 is a plan view of the plate member in accordance with the present invention.

FIG. 3 is a perspective view of the implant with hexagonal protrusion.

FIG. 4 is a perspective view of the implant with hexagonal depression.

FIG. 5 is an illustration of an exploded view of the dental implant stabilizing device being installed.

FIG. 6 is an illustration of the dental implant stabilizing device after installation.

### FIGURES—REFERENCE NUMERALS

10 . . . Dental Implant Stabilizing Device
12A . . . First Embodiment of the Implant
12B . . . Second Embodiment of the Implant
14 . . . Plate Member
16 . . . Side of the Plate Member
18 . . . Top Edge
20 . . . Bottom Edge
22 . . . Central Hole
24 . . . Screw
26 . . . Maxillary Bone
28 . . . Hexagonal Protrusion
30 . . . Hexagonal Depression
32 . . . Screw Hole

### DETAILED DESCRIPTION

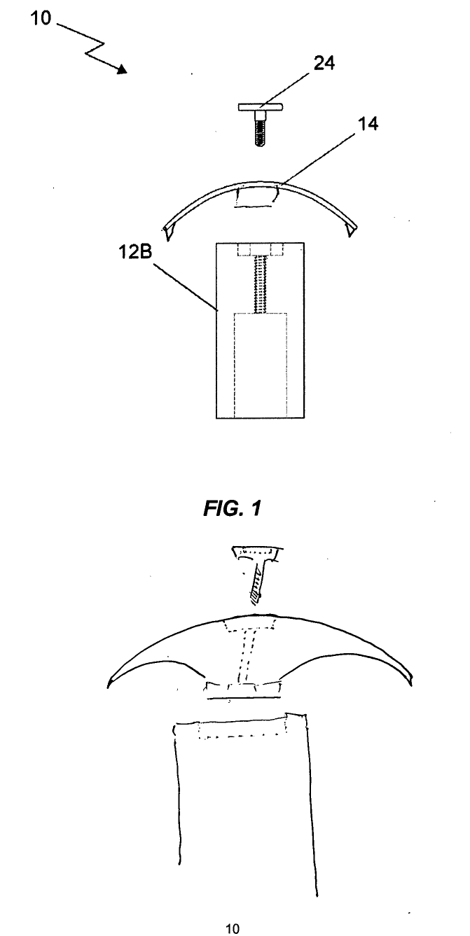

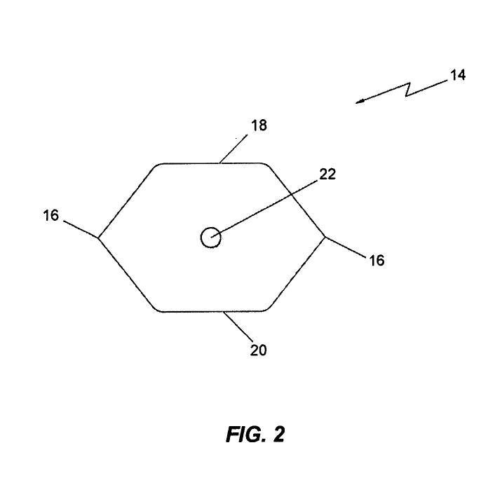

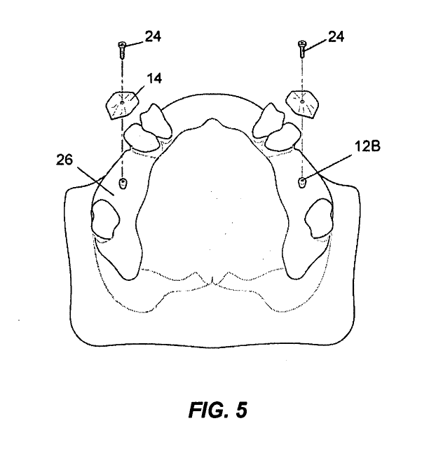

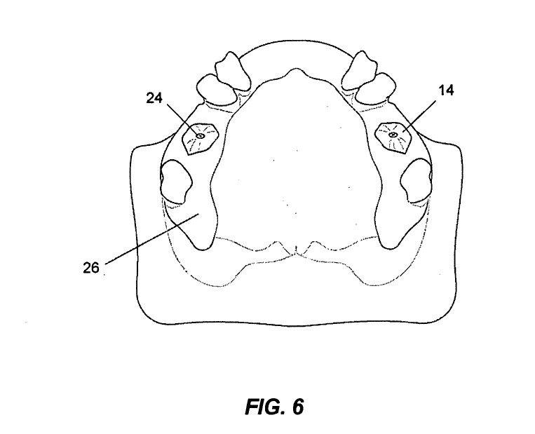

Referring to the drawings, a preferred embodiment of a dental implant stabilizing device is illustrated and generally indicated as 10 in FIGS. 1 through 6. The device 10 is purposed for holding a dental implant 12 in place essentially during the period between a dental implantation surgery and the osseointegration of the dental implant after the surgery.

Referring to FIGS. 1 through 4, the device 10 comprises a plate member 14, implant 12A and 12B and a screw 24. The plate member 14 resembles, on plan, the shape of two isosceles trapezoids joined at their bases in a same plane. The two sides 16 of the plate member 14 are pointed whereas the corners of the top and bottom edges 18 and 20 of the plate member 14 are sufficiently smoothened or rounded as seen in the figure. The plate member 14 is of concave/convex curvature. More specifically, the plate member 14 is uniformly curved between the two pointed ends. Also, the plate member 14 includes a central hole 22.

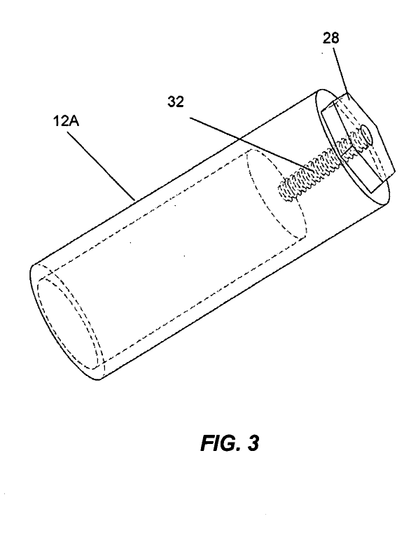

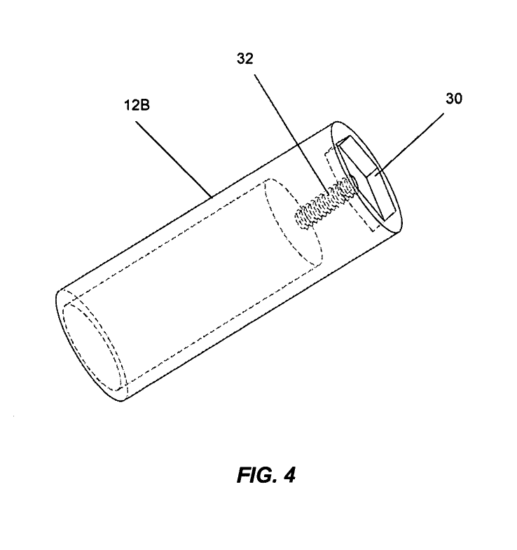

In a first embodiment as shown in FIG. 3, the implant 12A has a protruding hexagonal protrusion 28 and a screw hole 32. In a second embodiment as shown in FIG. 4, the implant 12B has hexagonal depression 30 and a screw hole 32. The hexagonal protrusion 28 of the implant 12A is adapted to be inserted into a hexagonal depression of a post. Similarly, the hexagonal depression 32 of the implant 12B is adapted to receive a hexagonal protrusion of a post. The hexagonal protrusion and depression therefore lock the rotational motion of the post against the implant.

Referring to FIGS. 1 through 6, the screw 24 is used for fastening the plate member 14 over the implant 12A and 12B, which is already implanted in the maxillary bone of a patient. The screw 24 is passed through the central hole 22 and the screw hole 32. The plate member is positioned such that the pointed ends abut the maxillary bone of the patient. Therefore, as the screw 24 is being tightened, the two pointed ends are anchored into the portion of the maxillary bone 26 which surrounds the implant 12A and 12B, thereby firmly securing the position of the implant 12. The plate member 14 is replaced with an artificial tooth once the implant 12 is osseointegrated.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A sinus implant stabilizing device, comprising:
(a) a dental implant for placement through the maxillary bone into the maxillary sinus;
(b) a plate member for placement over the mouth side of the maxillary bone and adapted to stabilize the implant after it is secured to the implant; and
(c) a fastener for securing the plate member to the implant after the plate member is placed over the mouth side of the maxillary bone.

2. The device of claim 1, wherein the plate member includes a curvature forming a convex configuration.

3. The device of claim 2, wherein the plate member comprises two opposite pointed ends extending from its circumference such that the plate member is uniformly curved between the two pointed ends

4. The device of claim 3, wherein the pressure exerted by the fastener on the plate member allows the pointed ends to anchor to the maxillary bone thereby stabilizing the implant firmly in place.

5. The device of claim 3, wherein the shape of the plate member on plan resembles the shape of two isosceles trapezoids joined together at their bases in a single plane.

6. The device of claim 1, wherein the plate member is made of metal.

7. The device of claim 1, wherein the implant comprises a locking mechanism for preventing rotational motion between the implant and a post with a tooth when they connected.

8. The device of claim 7, wherein the locking mechanism comprises a male to female locking mechanism.

9. The device of claim 8, wherein the implant comprises a hexagonal protrusion adapted to be received in a hexagonal depression of the post.

10. The device of claim 8, wherein the implant comprises a hexagonal depression adapted for receiving a hexagonal protrusion depression of the post.

11. The device of claim 1, wherein the implant includes a threaded hole, the plate member includes a hole at its center and the fastener comprises a screw, wherein the screw is passed through the threaded hole and the hole on the plate member.
